(19) United States
(12) Patent Application Publication
(10) Pub. No.: US 2008/0042438 A1
(43) Pub. Date: Feb. 21, 2008

(54) Hydraulic fitting and method of manufacture

(76) Inventors: Michael John Browne, Easley, SC (US); Sean Clary McDaniel, Pickens, SC (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/498,720

(22) Filed: Aug. 4, 2006

(51) Int. Cl. F16L 19/00

(52) U.S. Cl. 285/386; 285/354; 285/332.1

(57) ABSTRACT

A hydraulic cone fitting includes a tube segment and a substantially frustoconical connecting segment integrally formed at one end of the tube segment. The connecting segment generally includes a substantially frustoconical sealing surface and a substantially frustoconical back surface. The connecting segment may be formed by punching or rolling the end of the tube segment. A method of manufacturing a hydraulic fitting includes expanding an end portion of a tube to form an expanded portion. Inner and outer regions of the expanded portion are then reduced, via punching or rolling operations, to form substantially frustoconical back and sealing surfaces, respectively.

### FIELD OF THE INVENTION

The present invention relates generally to fittings for use in hydraulic systems. More particularly, the present invention relates to a unitary fitting for use in hydraulic systems.

### BACKGROUND OF THE INVENTION

In hydraulic systems, it is often necessary to interconnect components, such as hoses and reservoirs, in fluid communication with each other. (The terms “hydraulic system” and “fluid system” are used interchangeably herein to refer to any system of flowing fluid, whether or not the fluid is under pressure.) One type of fitting often used to interconnect fluid system components is a cone fitting, which includes a tube portion and a frustoconical connecting portion located at one end of the tube portion. As one skilled in the art will appreciate, cone fittings are commonly available in standardized sizes and dimensions (i.e., a ¼″ or ½″ diameter tube and a 24 degree cone sealing surface on the connecting portion). One skilled in the art will also recognize that the tube portion is designed to couple to an upstream hose, while the connecting portion is designed to mate with a complementary adapter attached to a downstream component. A fastener releasably secures the cone fitting to the adapter.

Extant cone fittings, however, are assembled from multiple components. That is, in extant cone fittings, the tube portion and the connecting portion are discrete parts. In some installations, the tube portion and the connecting portion are held together by nothing more than the compressive forces exerted thereon by the fastener and the adapter when the two are engaged with each other. In the absence of these compressive forces, therefore, such as when the fastener is not engaged with the adapter, the connecting portion can easily fall from the end of the tube portion, potentially becoming lost and frustrating the installer. This, of course, complicates installation of the cone fitting insofar as it requires the installer to manually exert sufficient force to hold the tube portion and connection portion together until the fastener is tightened to the adapter. Additionally, the installer must take care to ensure that the connecting portion and the tube portion are properly aligned, lest gaps be introduced between the tube portion and the connecting portion, thereby compromising the fluid system by providing leak paths for the fluid therein. Even if the connecting portion and the tube portion are initially properly aligned, operation of the fluid system, especially under impulse pressures, may introduce gaps between the two over time.

To combat the possibility of gaps, some extant cone fittings fixedly attach the connecting portion to the tube portion. For example, it is known to join the connecting portion to the tube portion via brazing. Brazing, however, increases the complexity, and therefore the cost, associated with manufacturing the cone fitting. Further, the connection introduces a seam susceptible to structural failure under pressure.

Accordingly, it is desirable to provide a method of manufacturing an integrated hydraulic cone fitting from a unitary workpiece, thereby eliminating the requirement to attach components via compression, brazing, or some other assembly step.

### SUMMARY OF THE INVENTION

The foregoing needs are met, to a great extent, by the present invention, wherein in one aspect a method of manufacture is provided that in some embodiments results in a unitary hydraulic cone fitting, thereby eliminating the need to assemble discrete components via compression, brazing, or other processes, and consequently enhancing the ease of assembling a hydraulic system.

In accordance with one embodiment of the present invention, a hydraulic fitting includes a tube segment and a substantially frustoconical connecting segment integrally formed at one end of the tube segment. The connecting segment generally includes a substantially frustoconical sealing surface and a substantially frustoconical back surface. The connecting segment may be punched or rolled from the end of the tube segment. The sealing surface mates with a complementary adapter attached to a downstream component, while the fastener securing the fitting to the adapter includes a complementary surface configured to mate with the back surface. The sealing surface and the back surface may have slope angles consistent with standardized hydraulic fitting dimensions, such as approximately 24° and approximately 45°, respectively.

In another aspect of the present invention, a method of manufacturing a unitary hydraulic fitting is disclosed. One end of a tube is expanded to create an expanded portion, which may be done in any number of successive expansion operations. An inner region and an outer region of the expanded portion are then reduced to form substantially frustoconical back and sealing surfaces, respectively. The back surface may also be formed simultaneously with one or more expansion operations by clamping the inner region adjacent a back surface die. Expansion and reduction may be accomplished by punching the tube, by rolling the tube, or by other machining or metalworking processes. The resulting fitting may then be coupled to a hose to create a hydraulic assembly for installation in a fluid system.

Yet another embodiment of the present invention provides a hydraulic assembly, generally including a hose and a hydraulic fitting. The hydraulic fitting includes a tube segment and a substantially frustoconical connecting segment. A first end of the tube segment is coupled to the hose, while the connecting segment is integrally formed at the opposite end of the tube segment. The hydraulic assembly may be installed in a fluid system with the hydraulic fitting releasably coupled to the fluid system via the connecting segment.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view illustrating a hydraulic fitting according to one embodiment of the invention.

FIG. 2 is a cross-sectional side view of a hydraulic assembly incorporating a hydraulic fitting according to one embodiment of the invention.

FIG. 3 is a flowchart illustrating steps that may be followed to manufacture a hydraulic fitting.

### DETAILED DESCRIPTION

The invention will now be described with reference to the drawing figures, in which like reference numerals refer to like parts throughout. An embodiment in accordance with the present invention provides a hydraulic fitting including a tube segment and a substantially frustoconical connecting segment integrally formed at one end of the tube segment. The connecting segment generally includes both a sealing surface, configured to mate with a downstream component in a fluid-tight manner, and a back surface on which a fastener rides. The tube segment may be coupled to an upstream hose. By constructing a hydraulic fitting from a unitary workpiece, the cost and complexity associated with assembling the fitting is reduced. In addition, unitary construction eliminates seams between discrete components of the hydraulic fitting, thereby enhancing the sealed, fluid-tight nature of the fluid system.

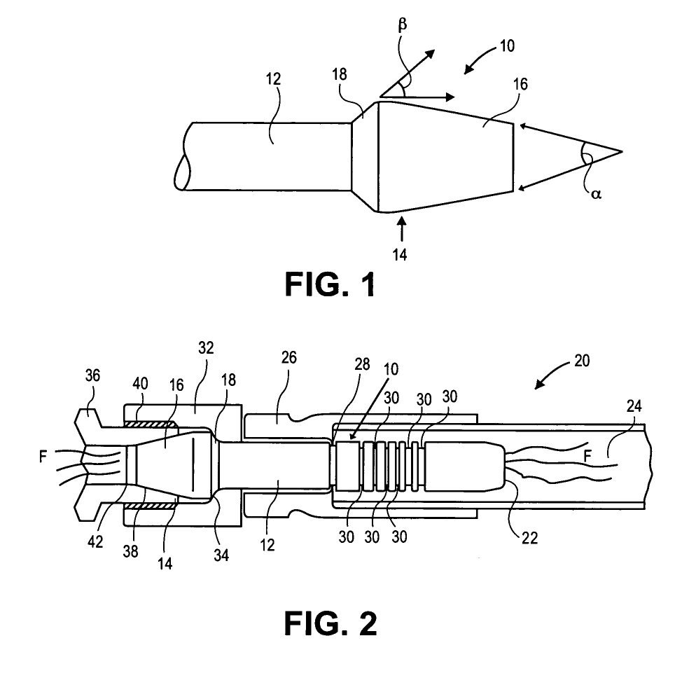

An embodiment of the present inventive apparatus is illustrated in FIG. 1. A hydraulic fitting 10 generally includes a substantially cylindrical tube segment 12 and a connecting segment 14. It should be understood that, though illustrated as straight, tube segment 12 may be formed in any desired path without departing from the spirit and scope of the present invention. For example, tube segment 12 may bend at an angle to fit within the dimensions of and conform to the shape of a vehicle engine compartment.

Connecting segment 14 is integrally formed at one end of tube segment 12. As one having ordinarily skill in the art should recognize from this disclosure, tube segment 12 and connecting segment 14 are a unitary component formed from a single workpiece, rather than an assembly of discrete components such as a connector fixedly or removably attached to a tube. In some embodiments of the invention, the workpiece used to form hydraulic fitting 10 is a mild carbon steel tube, though other materials are regarded as within the scope of the present invention.

Connecting segment 14 is substantially frustoconical in shape and includes a substantially frustoconical sealing surface 16 having a slant angle α and a substantially frustoconical back surface 18 having a slant angle β. In some embodiments of the present invention, sealing surface 16 is a 24-degree sealing surface, while back surface 18 is a 45-degree back surface, such as provided for in ISO 8434-1. That is, angle α is approximately equal to 24°, and angle β is approximately equal to 45°. It should be understood that, though sealing surface 16 and back surface 18 are depicted in FIG. 1 as plane surfaces having constant slope angles α and β, other configurations are contemplated. For example, slope angle α could vary such that sealing surface 16 is convex or concave. Further, the actual slope angle α or β may only approximate the desired angle by varying slightly thereabout within range of acceptable values governed by manufacturing tolerances or standards (i.e., a back surface 18 slope angle β of 45°±°) without departing from the present invention. In certain embodiments of the present invention, other slope angles α and β may be formed in connecting segment 14 without departing from the scope of the present invention. Connecting segment 14 may be formed by any suitable machining process, including, but not limited to, punching or rolling the end of tube segment 12.

FIG. 2 is a cross-sectional view of a hydraulic assembly 20 incorporating hydraulic fitting 10, such as might be installed in a hydraulic system, including, but not limited to, a vehicle fuel system, brake system, or power train. The end 22 of tube segment 12 opposite connecting segment 14 is disposed within an upstream hose 24 conducting a fluid F, which may be under pressure. Tube segment 12 is secured to hose 24, for example via a collar 26 engaged with a locking groove 28 on tube segment 12. A series of sealing grooves 30 serve to seal hose 24 to hydraulic fitting 10, in particular tube segment 12. One skilled in the art will recognize that the number of sealing grooves 30 may vary with the diameter of hydraulic fitting 10.

A fastener 32, such as a locking nut, quick disconnect slip ring, or any other suitable fastener, encompasses tube segment 12 adjacent connecting segment 14. As should be clear from FIG. 2, fastener 32 is placed around hydraulic fitting 10 before hose 24 is connected thereto. The interior surface 34 of fastener 32 is configured to complement, mate with, and ride on back surface 18 of connecting segment 14.

Connecting segment 14, in particular sealing surface 16, is then engaged with an adapter 36 connected to a downstream element (not shown) in the hydraulic system. The interior surface 38 of adapter 36 complements, mates with, and seals on sealing surface 16 to form a fluid-tight seal between hydraulic fitting 10 and adapter 36. In addition to the direct engagement between sealing surface 16 and interior surface 38 depicted in FIG. 2, it is within the spirit and scope of the present invention to provide an intermediary, such as a gasket or PTFE tape, between sealing surface 16 and interior surface 38 to facilitate or enhance the desired fluid-tight seal.

Once connecting segment 14 is engaged with adapter 36, fastener 32 is engaged to releasably couple hydraulic assembly 20, in particular hydraulic fitting 10, to adapter 36. This may be achieved, for example, via mating internal and external threads 40 on fastener 32 and adapter 36, respectively. That is, fastener 32 is screwed onto adapter 36. Alternatively, fastener 32 and adapter 36 may be complementary components of a quick-disconnect slipping connector. Since interior surface 34 of fastener 32 is mated with back surface 18, attaching fastener 32 to adapter 36 (e.g., via threads 40) compresses sealing surface 16 against interior surface 38, thereby facilitating the fluid-tight seal between hydraulic fitting 10 and adapter 36. Hydraulic assembly 20 may be quickly and easily uncoupled from the hydraulic system simply by detaching fastener 32 from adapter 36 and disengaging hydraulic fitting 10 from adapter 36.

A fluid F, such as coolant, flows in hose 24, such as a coolant line, originating from an upstream fluid source (not shown), such as a coolant reservoir. Fluid F may be under pressure. Fluid F enters hydraulic fitting 10 at end 22 of tube segment 12. It is then discharged into a downstream component (not shown), to which adapter 36 is attached, through a nozzle 42 at the end of connecting segment 14. The downstream component may be, for example, the power plant of a vehicle.

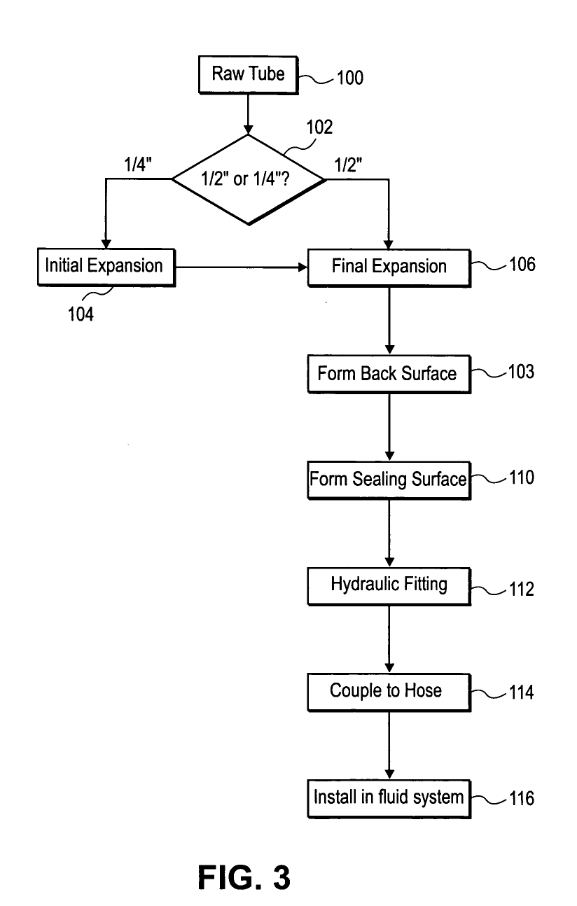

A method of manufacturing hydraulic fitting 10 will now be described with reference to the flowchart of FIG. 3. For purposes of this description, hydraulic fitting 10 will be assumed to be a 24 degree cone fitting (that is, a hydraulic fitting 10 where sealing surface 16 has a constant slope angle α of approximately 24°). It should be understood, however, that the process is not so limited, and may equally be used to manufacture hydraulic fittings 10 of other dimensions. It is also assumed that back surface 18 has a constant slope angle β of 45°, though it should be recognized that the process described may be practiced to achieve any other constant or variable slope angle β as may be desired in a particular application of the present invention. Further, one skilled in the art will recognize that, though tube segments 12 of such fittings are often either of ½″ or ¼″ diameter, the process described below may equally be practiced on tubes of other diameters.

A raw tube from which hydraulic fitting 10 will be formed is provided in step 100. As noted above, the tube may be a mild carbon steel tube, though tubes composed of other machineable materials are regarded as within the spirit and scope of the present invention. In step 102, the diameter of the tube is identified. If the tube is of ¼″ diameter, the left-hand path is followed to step 104, wherein the end of the tube is expanded to a first expanded diameter in an initial expansion operation. The process then proceeds to step 106, wherein the end of the tube is expanded to a second expanded diameter in a final expansion operation. If the tube is of ½″ diameter, the right-hand path is followed directly to step 106 for final expansion. The additional expansion operation of step 104 is required for the smaller diameter tube because of the more substantial increase in diameter for a ¼″ diameter tube relative to a ½″ diameter tube (roughly a 50% increase in diameter as compared to roughly a 25% increase in diameter). Either or both expansion operations 104, 106 may be performed by using a pin punch, inserted into the inner diameter of the tube, to expand the end of the tube. In other embodiments of the invention, either or both expansion steps 104, 106 are performed by rolling the end of the tube to the expanded diameter. In still other embodiments of the invention, either or both expansion steps 104, 106 are performed using another appropriate machining or metalworking technique.

In step 108, an inner segment of the expanded portion of the tube is reduced to form a substantially frustoconical back surface 18. In some embodiments of the present invention, steps 106 and 108 occur simultaneously by punching the end of the tube with the inner segment clamped adjacent a back surface die, for example a constant 45 degree die. Thus, when the end of the tube is punched in step 106, the die acts to form back surface 18 in step 108. However, steps 106 and 108 may occur separately without departing from the spirit and scope of the present invention. As with expansion steps 104 and 106, step 108 may also be performed by rolling the inner segment into the desired shape of back surface 18 or by another appropriate machining or metalworking technique.

Sealing surface 16 is formed in step 110 by reducing an outer segment of the expanded portion into a substantially frustoconical shape. Step 110 may be performed by punching the outer segment with a suitable punch, for example a constant 24 degree punch. Step 110 may also be performed by rolling the outer segment into the desired shape or through another appropriate machining or metalworking operation.

The result, in step 112, is a 24 degree cone hydraulic fitting 10 with a 45 degree back angle. As described above, hydraulic fitting 10 may be coupled to hose 24 and installed in a fluid system in steps 114 and 116, respectively.

Although hydraulic fitting 10 has been described in connection with a vehicle hydraulic system, and in particular a vehicle coolant system, one skilled in the art will recognize that it may equally be utilized in any fluid system having interconnected components in fluid communication with each other. Further, though the assembly of FIG. 2 has been described with reference to a unitary adapter 36 connected to a downstream component, one skilled in the art should recognize that multiple discrete components may collectively comprise adapter 36 (i.e., a first component configured to mate with sealing surface 16 and a second component configured to releasably engage fastener 32). In addition, though ½″ and ¼″ diameter examples of hydraulic fitting 10 have been discussed herein, the scope of the invention is not so limited and may equally be practiced to create a fitting of any desired diameter.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A hydraulic fitting, comprising:
a tube segment; and
a substantially frustoconical connecting segment integrally formed at one end of said tube segment.

2. The hydraulic fitting according to claim 1, wherein said connecting segment comprises a substantially frustoconical sealing surface and a substantially frustoconical back surface.

3. The hydraulic fitting according to claim 2, wherein said sealing surface comprises a sealing surface having an approximately 24 degree slope angle.

4. The hydraulic fitting according to claim 2, wherein said back surface comprises a back surface having an approximately 45 degree slope angle.

5. The hydraulic fitting according to claim 1, wherein said connecting segment is punched onto said end of said tube segment.

6. The hydraulic fitting according to claim 1, wherein said connecting segment is rolled into said end of said tube segment.

7. A method of manufacturing a hydraulic fitting, the method comprising:
expanding a portion of a tube proximate an end thereof;
reducing an inner region of the expanded portion into a substantially frustoconical back surface; and
reducing an outer region of the expanded portion into a substantially frustoconical sealing surface.

8. The method according to claim 7, wherein expanding a portion of the tube proximate an end thereof comprises punching the end of the tube.

9. The method according to claim 8, wherein reducing an inner region of the expanded portion comprises punching the end of the tube while the inner region of the tube is clamped adjacent a back surface die.

10. The method according to claim 7, wherein reducing an outer region of the expanded portion comprises punching the outer region of the expanded portion.

11. The method according to claim 7, wherein expanding a portion of the tube proximate an end thereof comprises:
expanding the portion to a first expanded diameter in a first expansion operation; and
expanding the portion to a second expanded diameter in a second expansion operation.

12. The method according to claim 7, wherein reducing an inner region of the expanded portion comprises reducing the inner region to a back surface having an approximately 45 degree slope angle.

13. The method according to claim 7, wherein reducing an outer region of the expanded portion comprises reducing the outer region to a sealing surface having an approximately 24 degree slope angle.

14. The method according to claim 7, further comprising:
coupling the hydraulic fitting to a hose to create a hydraulic assembly; and
installing the hydraulic assembly in a fluid system.

15. The method according to claim 7, wherein expanding a portion of the tube proximate an end thereof comprises rolling the end of the tube.

16. The method according to claim 7, wherein reducing an inner region of the expanded portion comprises rolling the inner region of the expanded portion of the tube.

17. The method according to claim 7, wherein reducing an outer region of the expanded portion comprises rolling the outer region of the expanded portion of the tube.

18. A hydraulic assembly, comprising:
a hose; and
a hydraulic fitting, comprising:
a tube segment, wherein a first end of said tube segment is coupled to said hose; and
a substantially frustoconical connecting segment integrally formed at a second end of said tube segment.

19. The hydraulic assembly according to claim 18, wherein said hydraulic assembly is installed in a fluid system.

20. The hydraulic assembly according to claim 18, wherein said hydraulic fitting is releasably coupled to the fluid system.
